(19) United States
(12) Patent Application Publication
(10) Pub. No.: US 2004/0109160 A1
(43) Pub. Date: Jun. 10, 2004

(54) Process for recognizing a register mark, preferably a colorless or color-reduced register mark

(76) Inventors: Wolfgang Eberhard Luxem, Kiel (DE); Rodney R. Bucks, Webster, NY (US); Klaus Muller, Heidelberg (DE)

Correspondence Address: Lawrence P. Kessler, Patent Department, NexPress Solutions LLC, 1447 St. Paul Street, Rochester, NY, 14653-7103, US

(21) Appl. No.: 10/665,034

(22) Filed: Sep. 17, 2003

(30) Foreign Application Priority Data
Oct. 14, 2002 (DE) 102 47 813.9
May 2, 2003 (DE) 103 20 064.9

(51) Int. Cl. G01B 11/00

(52) U.S. Cl. 356/400; 356/399

(57) ABSTRACT

A process for recognizing a colorless or color-reduced register mark by recording reflected or remitted electromagnetic radiation, particularly of visible or invisible light such that the register mark can be more reliably identified with particularity. The register mark is given an environment contrasting with the register mark, preferably installed beneath it, that absorbs an amount of radiation different from the amount the register mark itself and/or an absorptive ground absorbs.

### FIELD OF THE INVENTION

The invention relates to a process for recognizing a register mark by recording reflected or remitted electromagnetic radiation, particularly of visible or invisible light, preferably of a register mark of transparent or clear toner.

### BACKGROUND OF THE INVENTION

For a color print, register resistance, the attitude of the printed impression to the paper (where applicable, even of the face print to the reverse print), the gauge-pin accuracy, the lie of the individual partially-colored extracts to each other or over one another, are all monitored and managed with the aid of register marks. Register marks can be applied on a substrate or, for instance, even on a transparent conveyor belt for the substrate, e.g. between sheets of the substrate, for transfer accuracy in the electrophotographic printing process. In the first case, with the aid at least of an appropriate sensor, register marks can be recognized by reflected light; and in the second case, register marks can be recognized by transmitted light. Substrate and conveyor belt or a different carrier will be spoken of collectively as “substrates.”

A color print is generally printed with four colors: cyan, magenta, yellow, and black, whereby the four color extracts of the print image to be printed are developed with four color decks that apply color and toner respectively to the substrate, as appropriate, in an electrophotographic printing process. Beyond that, applying a transparent substance on the color picture can be planned, particularly a colorless toner on a toner picture. This can serve to protect the picture, but optionally the gloss of the picture can be intensified. For example, applying a colorless toner on a toner picture, as a supplement, is well established from U.S. Pat. No. 5,147,745; U.S. Pat. No. 5,506,671; and EP-B-0 081 887. This can generally be accomplished with a multi-colored color deck. It is also necessary to introduce the colorless toner into the registry for correct positioning of the colorless toner on the color picture. This could happen by a further register mark from the colorless toner. The problem there is that a colorless or color-reduced register mark on a common, ordinarily relatively bright substrate, paper for example, cannot with adequate certainty be recognized by a sensor by light reflection. A register mark from a colored toner on a colored substrate, for instance, can be recognized because the substrate reflects a great deal of light, although diffusely, while the toner absorbs a great deal of light. For example, however, a clear toner reflects light very much as the substrate does, particularly in the visible range of light, in the close infrared and the close ultraviolet range of light. Thus, relief could be sought through the addition of special absorbers to the clear toner, particularly for absorption in the infrared and/or the ultraviolet range in order not to affect the appearance of the toner in the visible range, but this is also problematic. Such absorbers are expensive, above all for the infrared range. Some absorbers, particularly in the ultraviolet range, adulterate the color of the printed impression anyhow. Moreover, additional special lighting would be necessary to make the absorbers effective. Appropriate sources of light are expensive, especially in the UV-range. They have slight capacity and necessitate additional optics. In addition, a toner has to have definite triboelectric and rheologic characteristics for a dependable printing process. However, these characteristics are likewise unfavorably affected by the absorbers mentioned. The same thing shown for toners is true by analogy for other print colors.

A problem related to the one illustrated above, that a register mark can be only poorly recognized optically, arises whenever a colored register mark is applied to a substrate that also is colored, especially where the substrate is somewhat similarly colored.

Pages to be printed are rather frequently carried on a transparent conveyor belt in an electrophotographic printing unit. Register marks are therefore often pressed into spaces between back-to-back sheets directly onto the conveyor belt. Then the register marks can be recognized with a kind of light cabinet in the transmitted light process. In this way it can also be possible to recognize transparent register marks on the transparent conveyor belt because in that case refractive, not reflective, characteristics play a role. These characteristics can vary with the conveyor belt and the transparent register marks, and/or polarization of the light can be used.

Nevertheless, in this connection the problem also arises that register marks between the sheets can be used to be sure, to calibrate the printing unit color-to-color (transfer accuracy), but for a registry color-to-sheet (register resistance) the register mark must be applied on the sheet itself. Then, however, the transmitted light process is once again inapplicable. If the color picture is to be protected primarily with a transparent frame, transfer accuracy could potentially be effectual. But if the gloss is to be changed completely in definite areas of the print image by a sort of transparent color extract, particularly then, a full-fledged registry has to be executed in all respects for the application of the transparent “color” as well as with each other color extract.

### SUMMARY OF THE INVENTION

The problem underlying this invention then is to reveal a process with which a register mark, particularly a colorless or color-deficient register mark, can dependably be recognized.

According to the invention, this problem is solved by giving the register mark an environment that absorbs an amount of radiation different from the amount the register mark itself and/or the substrate absorbs, and that is in contrast to the register mark and/or the substrate. This can be used equally for recognizing the colorless or the colorful register marks. Where the register mark is colorless or color-reduced, the register mark is preferably given an environment that contrasts with the register mark, one that absorbs radiation more powerfully than the register mark itself.

In the solution according to the invention, the environment of the register mark to be identified is shaped differently in a surprisingly simple and effective way. It is more absorbent than the register mark and the substrate, so that the register mark, quasi embedded in this environment, can be confidently and exactly recognized in that essentially in one sensor several transitions of yield of light reflectivity can be registered. For example, this is accomplished by the high yield through the substrate, then less reflectivity from an environmental angle, and again high reflectivity from the first angle of the register mark, afterwards, from the second angle of the transparent register mark again less reflectivity in the environment and once again high reflectivity on the substrate after leaving the environment or even in reverse or complementary sequence. Since the sequence of markings in the transfer direction of the substrate and their dimensions (angle intervals) are known, the position of the register mark to be recognized can be either recognized immediately or computed.

Since the sequence of markings is known, the register mark to be recognized does not have to be defined at its two angles by an otherwise absorbent environment, but, according to the invention, it can be satisfactorily arranged for the register mark to be placed adjacent only to at least one contrasting surface, particularly if the contrasting surface of the register mark precedes in the transfer direction and initiates a kind of activation signal for recognition of the registry.

Especially as provided for in a further development of the invention, the register mark to be recognized can also be placed on or above a contrasting surface, that has a greater surface than the register mark and/or surmounts it at least in one direction.

A particularly advantageous solution according to the invention provides that the contrasting surface itself also is shaped like a register mark. It is even preferred that at least one allotted register mark will be used as a contrasting surface anyway. In this way the register mark to be recognized, especially an additional transparent register mark, could be drawn advantageously into a group of register marks, whereby the register mark to be recognized could be imprinted on a larger register mark, for example, or placed precisely between two register marks.

The contrasting surface can be formed in particular by a colored toner, whereby a black toner is especially advantageous and appropriate because of its high absorption. This is especially advantageous for recognition of a transparent register mark that itself reflects rather strongly. It is advantageous, for example, in recognizing a colored register mark on a substrate of the same color if in contrast to it a toner is used that shows a color other than the register mark to be recognized and/or the substrate. In that case, the condition “and” in identical color of the register mark to be recognized and the substrate comes especially into consideration.

As already further indicated above, according to the invention it can be arranged preferentially that the position of the register mark to be recognized is established with the help of the position of the contrasting register mark, to investigate advantageous angle intervals of the contrasting register mark.

The invention, and its objects and advantages, will become more apparent in the detailed description of the preferred embodiment presented below.

### BRIEF DESCRIPTION OF THE DRAWINGS

In the detailed description of the preferred embodiment of the invention presented blow, reference is made to the accompanying drawings, in which:

FIG. 1 is an ordinary state-of-the-art group of register marks viewed from above;

FIG. 2 is a group of register marks with a transparent register mark according to the invention viewed from above as in FIG. 1;

FIG. 3A is a transparent register mark in dead center (centered) on a colored register mark that serves as a contrasting surface; and

FIG. 3B is a transparent register mark that is displaced on the colored register mark as in FIG. 3A, not centered (eccentric).

### DETAILED DESCRIPTION OF THE INVENTION

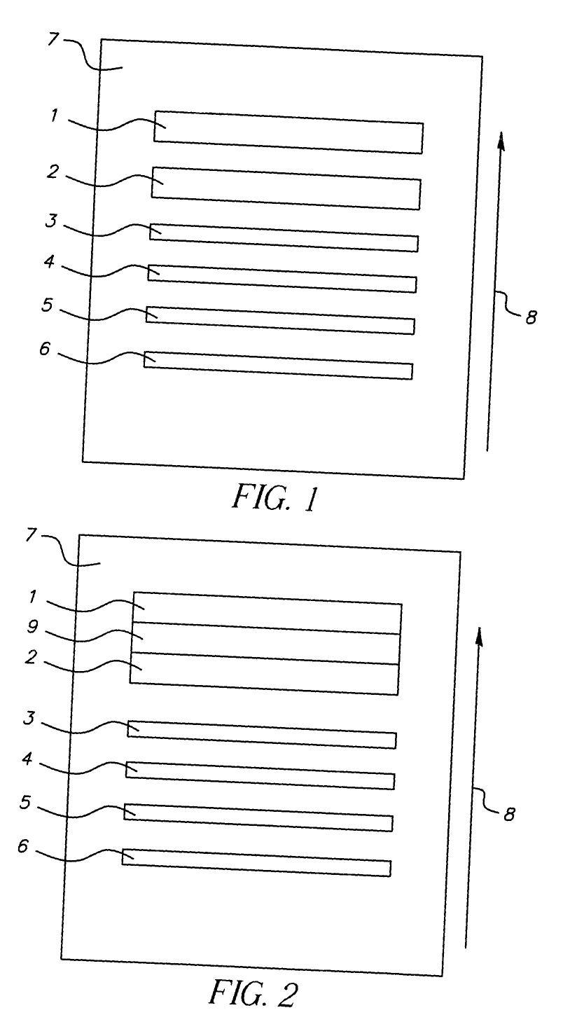

Referring now to the accompanying drawings, FIG. 1 shows an overview of a group of register marks 1-6, as they usually are in the known prior art and especially as they can be applied to the registry on a substrate 7, indicated as a frame. Transfer direction of the substrate 7, can be assumed to be in the direction of the arrow 8. Next, the two broader register marks are represented 1 and 2 black, leading in transfer direction 8, and the subsequent register marks 3 to 6, the colored register marks, are represented in the four print colors, cyan, magenta, yellow, and black.

In FIG. 2 once again a group of register marks like those in FIG. 1 is shown, where the same elements are marked with the same reference numbers as in FIG. 1. In FIG. 2 yet another transparent register mark 9, has been added to the group of register marks. This transparent register mark 9, can be inserted, according to the invention, directly between the retained register marks 1 and 2, with their same width. Better than that, according to the invention, a widened, black contrasting surface 1 (2), is planned that covers the surface of register marks 1, 2, and 9, and onto which the register mark 9, is brought up as close to dead center as possible (centered).

Thus, the position of a colored register mark can always be determined, for example, in that the angle of the colored register mark leading in the transfer direction 8, is recognized first of all by a sensor because a transfer occurs from brightly reflected light yield to more darkly reflected light yield; the angle of the colored register mark at the rear with respect to the transfer direction is recognized, because a transfer of more darkly reflected light yield to more brightly reflected light yield occurs. Then, out of the separation of the two recognized angles, at dead center between them, the center line of the register mark is determined as the position of the register mark.

The position of the transparent register mark 9, to be found on the colored register mark or contrasting surface 1 (2), can always be determined in exactly the same way, but illustrated in reverse as compared with a colored register mark. Initially a dark-to-bright transfer occurs at the leading angle of the transparent register mark 9, because of the preceding darker register mark surface, 1, and at the rear angle of the transparent register mark 9, a bright-to-dark transfer occurs because of the subsequent register mark surface 2. The transparent register mark 9 thus yields in a sensor a signaling process precisely inverse to the signaling process yielded through a colored register mark.

The register mark positions ascertained can be fed as values of machine control software that thus manages the printing machine correspondingly.

It may be indicated only provisionally at this point that, given an electrophotographically operating printing unit, in a process according to the invention, register marks could be recognized, for example, even on the surface of a photoconductor drum, or a photoconductor strip or on a transfused rubber blanket instead of on a substrate or a conveyor belt.

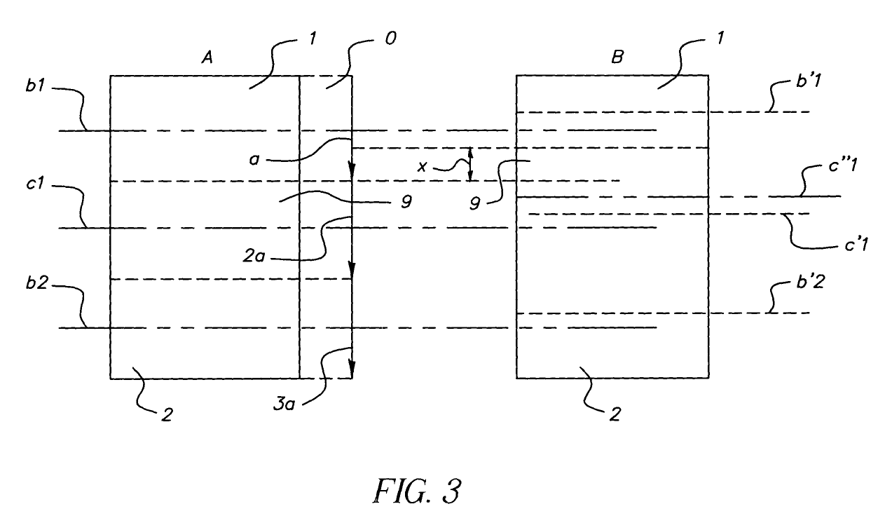

With the help of FIGS. 3A and 3B it ought to be exemplified once more concretely, how the position of the transparent register mark 9, is calculated on the contrasting surface 1, 2, forming on the register marks 1 and 2, as indicated above, and in fact, whenever the transparent register mark 9, is arranged precisely centered on the contrasting surface 1, 2, as in FIG. 3A and in comparison with it, as in FIG. 3B, whenever the transparent register mark 9, is displaced somewhat excentrically vis-a-vis the contrasting surface 1, 2, around a route x marked with a double-headed arrow.

In FIG. 3A the transparent register mark 9 is brought up centered on the contrasting surface 1, 2. This should mean that the register marks 1, 2, and 9, each have a width in transfer direction 8, (FIG. 2) of the substrate 7, of a specific amount a. Therefore, if a distance traveled toward the transfer distance 8 is calculated, as indicated in FIG. 3A, starting at the leading angle of register mark 1, with the value 0, then the rear angle of register mark 1, that at the same time is the leading angle of the transparent register mark 9, has the value a; the rear angle of register mark 9, and at the same time the leading angle of register mark 2, has the value 2a; and the rear angle of register mark 2, has the value 3a, as also indicated with an arrow sequence.

Register mark 1, has on it the chain-dotted axis b1 that is taken as the position of register mark 1; the transparent register mark 9, has the chain-dotted axis c1, and register mark 2, has the chain-dotted axis b2. The axes b1 and c1 and the axes c1 and b2 also have respectively a distance a to one another.

As calculated, measured from the value of the distance covered 0, for the positions of the axes of register marks 1, 2 and 9, this means the following:

$$\begin{matrix}b1 = \frac{a}{2} & ( 1 ) \\ b2 = \frac{5}{2} \cdot a & ( 2 ) \\ c1 = b1 + \frac{b2 - b1}{2} = \frac{3}{2} \cdot a & ( 3 )\end{matrix}$$

Whenever the transparent register mark 9 is shifted on the consistently large, that is 3a long or wide contrasting surface 1, 2, as in FIG. 3B for a distance x, somewhat different calculations arise. On displacement of the transparent register mark 9 in transfer direction 8, as shown in FIG. 3B, register mark 1 becomes smaller because of the consistently large total contrasting surface, and register mark 2 becomes wider. This leads to changed positions for both axes b′1 and b′2 of these two register marks consistent with the following formulas:

$$\begin{matrix}{b1}^{′} = \frac{a - x}{2} & ( 6 ) \\ {b2}^{′} = \frac{5}{2} \cdot a - \frac{x}{2} & ( 7 )\end{matrix}$$

If, out of (6) and (7), an axis c′1 of the transparent register 9 is computed, seemingly lying directly between the two axes b′1 and b′2, that is represented by dashes like axes b′1 and b′2 in FIG. 3B, the results would be as follows:

$${c}^{′} 1 = {b}^{′} 1 + \frac{{b}^{′} 2 - {b}^{′} 1}{2} = \frac{3}{2} \cdot a - \frac{x}{2} \qquad ( 8 )$$

as is also recognizable geometrically from FIG. 3B. Similarly, it is immediately clear that the real axis c″1, represented in FIG. 3B by a line consisting of repetitions of a dash followed by two dots, is shifted around x, since an x-shift of register mark 9 was just contemplated and predetermined as the case. So it appears then that the actual value of c″1 varies from the calculated value of c′1 just by

$$- \frac{x}{2} ,$$

for the desired position of c″1 lies in fact at:

$${c}^{″} = c1 - x = \frac{3}{2} \cdot a - x \qquad ( 9 )$$

Thus it is clear that on comparison of the position of c1 to be estimated through calculation based on a precisely placed register mark 9, and the position of c′1 actually computed when register mark 9, is shifted, only half the displacement error is calculated in the following way:

$$c1 = {c}^{′} 1 = \frac{3}{2} \cdot a - \frac{3}{2} \cdot a + \frac{x}{2} = \frac{x}{2} \qquad ( 10 )$$

so that machine management must be corrected for twice the amount calculated as remaining at (10).

With the method delineated above, for example, it is also possible more reliably to recognize a colored register mark 9, instead of a transparent one, if it is of the same color as the carrier on which it is placed, for example. In that case, it is necessary to select contrasting surfaces 1, 2, of a color different from that of the register mark to be recognized and the carrier.

The invention has been described in detail with particular reference to certain preferred embodiments thereof, but it will be understood that variations and modification can be effected within the spirit and scope of the invention.

What is claimed is:

1. Process for recognizing a colorless or color-reduced register mark on a substrate, by recording reflected or remitted electromagnetic radiation (light), comprising: the register mark is given an environment that absorbs an amount of radiation different from the amount that the register mark itself and/or the substrate absorbs, and/or contrasts with the register mark and/or the substrate.

2. Process according to claim 1, wherein, there is given to the colorless or color-reduced register mark an environment that contrasts with the register mark and absorbs radiation more powerfully than the register mark itself.

3. Process according to claim 1, wherein, the register mark is placed adjacent to at least one contrasting surface.

4. Process according to claim 1, wherein, the register mark is placed on a contrasting surface that has a larger surface than the register mark and/or surmounts it at least in one direction.

5. Process according to claim 1, wherein, the contrasting surface itself also is shaped like a register mark.

6. Process according to claim 5, wherein, at least one register mark designated apart from this as a contrasting surface, is used.

7. Process according to claim 3, wherein, the contrasting surface is formed by a colored toner.

8. Process according to claim 7, wherein, black toner is used.

9. Process according to claim 7, wherein, a toner is used that shows another color as the register mark to be recognized and/or as the substrate.

10. Process according to claim 5, wherein, the position of the register mark to be recognized is calculated with the aid of the position of the contrasting register mark.

11. Process according to claim 5, wherein, angle positions of the contrasting register mark are calculated.
